(19) United States
(12) Patent Application Publication
(10) Pub. No.: US 2015/0262478 A1
(43) Pub. Date: Sep. 17, 2015

(54) SETTING UPDATE SYSTEM AND VEHICLE CONTROL SYSTEM

(71) Applicant: KABUSHIKI KAISHA TOSHIBA, Minato-ku (JP)

(72) Inventor: Takufumi YOSHIDA, Funabashi (JP)

(73) Assignee: KABUSHIKI KAISHA TOSHIBA, Minato-ku (JP)

(21) Appl. No.: 14/603,554

(22) Filed: Jan. 23, 2015

(30) Foreign Application Priority Data
Mar. 17, 2014 (JP) 2014-054147

(51) Int. Cl. G08G 1/00

(52) U.S. Cl. CPC G08G 1/00

(57) ABSTRACT

A setting update system according to one embodiment updates an upper limit value of the number of vehicles, which travel in an area including a plurality of zones in response to a traveling request, set per zone depending on the number of the traveling requests in each of the zones.

### CROSS REFERENCE TO RELATED APPLICATION(S)

This application is based upon and claims the benefit of priority from the prior Japanese Patent Application No. 2014-054147, filed on Mar. 17, 2014, the entire contents of which are incorporated herein by reference.

### FIELD

Embodiments described herein relate generally to a setting update system and a vehicle control system.

### BACKGROUND

Conventionally, vehicles which travel in an area including a plurality of zones in response to a traveling request are employed in a plant or the like. Generally, a range of the number of vehicles in each zone (which will be called “number of vehicles” below) is set and the number of vehicles in each zone is controlled within the set range. Conventionally, the range of the number of vehicles is manually set, and a proper range is difficult to set. Therefore, there is a problem that an upper limit value of the number of vehicles is improperly set, which causes a clog of the vehicles in the area and reduces a working efficiency of the plant.

### BRIEF DESCRIPTION OF THE DRAWINGS

FIG. 1 is a block diagram illustrating a functional configuration of a vehicle control system according to a first embodiment;

FIG. 2 is a block diagram illustrating a hardware configuration of a vehicle controller;

FIG. 3 is a block diagram illustrating a hardware configuration of a zone controller:

FIG. 4 is a block diagram illustrating a hardware configuration of a host system;

FIG. 5 is a block diagram illustrating a hardware configuration of a setting update system;

FIG. 6 is a diagram illustrating an exemplary vehicle number/traveling rate relationship;

FIG. 7 is a diagram illustrating an exemplary area;

FIG. 8 is a flowchart illustrating a setting update processing by the setting update system according to the present embodiment;

FIGS. 9A and 9B are explanatory diagrams for explaining traveling request information;

FIG. 10 is a diagram illustrating an exemplary number of traveling request table;

FIG. 11 is a diagram illustrating an exemplary vehicle number/traveling rate table;

FIG. 12 is a diagram illustrating an exemplary critical traveling rate table;

FIG. 13 is a diagram illustrating an exemplary load rate table;

FIG. 14 is a diagram illustrating an exemplary upper limit traveling rate table;

FIG. 15 is a diagram illustrating an exemplary upper limit vehicle number table;

FIG. 16 is a block diagram illustrating a functional configuration of a vehicle control system according to a second embodiment;

FIG. 17 is a diagram illustrating an exemplary lower limit vehicle number table;

FIG. 18 is a block diagram illustrating a functional configuration of a vehicle control system according to a third embodiment; and

FIG. 19 is a diagram illustrating an exemplary priority table.

### DETAILED DESCRIPTION

Embodiments will now be explained with reference to the accompanying drawings. The present invention is not limited to the embodiments.

A setting update system according to one embodiment updates an upper limit value of the number of vehicles, which travel in an area including a plurality of zones in response to a traveling request, set per zone depending on the number of the traveling requests in each of the zones.

### First Embodiment

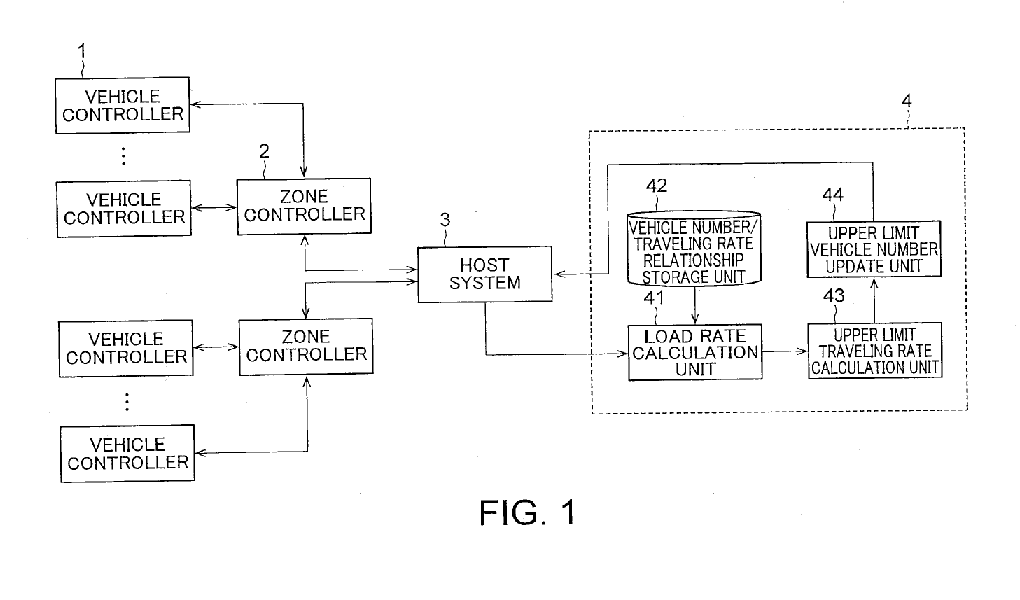

A vehicle control system and a setting update system according to a first embodiment will be first described with reference to FIGS. 1 to 15. In the present embodiment, the vehicle control system controls the traveling of a plurality of vehicles traveling in an area including a plurality of zones in response to a traveling request.

The vehicles may be automated guided vehicles (AGV) which autonomously and dispersively travel according to information on an inter-vehicular distance relative to an ahead-vehicle, or manned vehicles such as carriers or transportation (including buses and taxies) driven by a driver.

The traveling request designates a traveling route of the vehicle. The vehicle travels through the traveling route designated in the traveling request. The traveling request may designate the departure point and arrival point of the vehicle, and the route therebetween may be previously determined depending on the departure point and the arrival point.

When the vehicle is an AGV, the vehicle autonomously travels down to the arrival point in response to a traveling request. When the vehicle is a manned vehicle, the vehicle is driven by a driver down to the arrival point in response to a traveling request. The area where the vehicle travels may or may not be provided with a trajectory rail configuring the traveling route of the vehicle. The traveling request may or may not be assigned with a vehicle.

In the present embodiment, a range of the number of vehicles in each zone is set, and the vehicle control system controls the number of vehicles in each zone within the set range.

FIG. 1 is a block diagram illustrating a functional configuration of the vehicle control system according to the present embodiment. As illustrated in FIG. 1, the vehicle control system according to the present embodiment comprises a plurality of vehicle controllers 1, a plurality of zone controllers 2, a host system 3 (issuance unit), and a setting update system 4.

The vehicle controller 1 is mounted on each vehicle traveling within an area, and wirelessly communicates with the zone controller 2. The vehicle controller 1 transmits positional information of the vehicle to the zone controller 2, and receives a traveling instruction from the zone controller 2. The traveling instruction is a traveling request assigned with a vehicle, and is generated and transmitted per vehicle. When a traveling request is previously assigned with a vehicle, the traveling request may be transmitted to the vehicle controller 1.

When the vehicle is an AGV, the vehicle controller 1 controls the vehicle to autonomously travel based on information on an inter-vehicular distance relative to an ahead-vehicle until receiving a traveling instruction, and when receiving a traveling instruction, controls the vehicle to travel through a traveling route designated by the traveling instruction.

When the vehicle is a manned vehicle, the vehicle controller 1 notifies the driver of a route to be travelled by the vehicle until receiving a traveling instruction, and when receiving a traveling instruction, notifies the driver of the arrival point or traveling route designated in the traveling request.

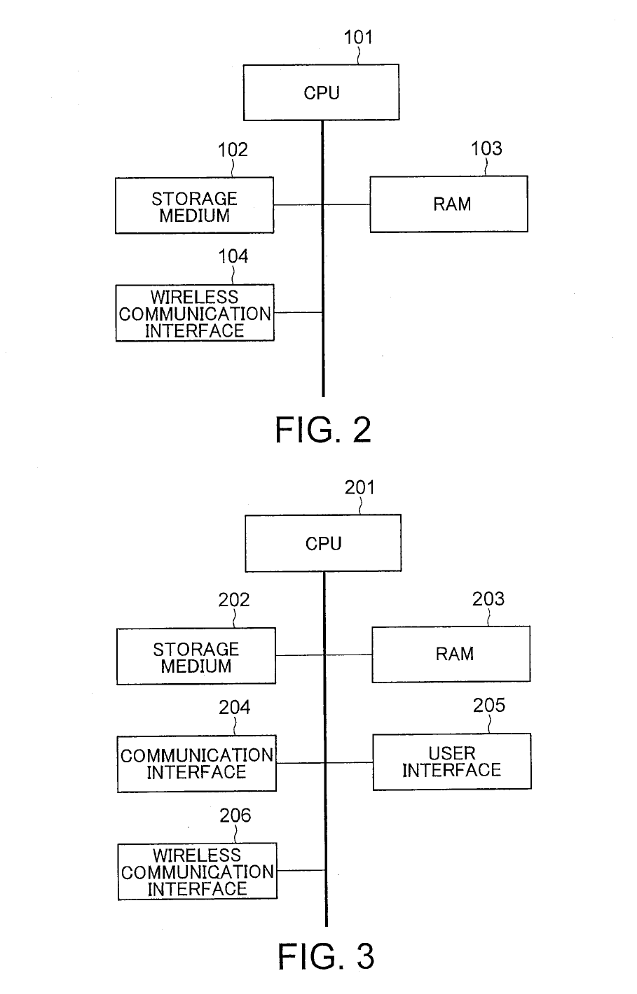

The vehicle controller 1 can be configured of a computer device. FIG. 2 is a block diagram illustrating a hardware configuration of the vehicle controller 1. As illustrated in FIG. 2, the computer device configuring the vehicle controller 1 comprises a CPU 101, a storage medium 102, a RAM 103, and a wireless communication interface 104, and the components are connected with each other via a hub.

The CPU 101 controls other components, and sequentially executes the programs stored in the storage medium 102. The storage medium 102 is configured of HDD or SSD, and stores the programs required to control the vehicle therein. The RAM 103 is configured of SRAM, DRAM, or a flash memory, and reads and temporarily stores the programs stored in the storage medium 102 as needed when the CPU 101 executes the programs, respectively. The wireless communication interface 104 wirelessly communicates with the zone controller 2, receives a traveling instruction from the zone controller 2 and transmits positional information on the vehicle to the zone controller 2. When the vehicle is a manned vehicle, the computer device may comprise a display for displaying a traveling instruction thereon.

The zone controller 2 is installed per zone in the area, wirelessly communicates with the vehicle controller 1 of the vehicle traveling in each zone, and communicates with the host system 3 via a LAN constructed in the area.

The zone controller 2 receives a traveling request from the host system 3, assigns a vehicle traveling in a zone to the received traveling request to generate a traveling instruction, and transmits the generated traveling instruction to the vehicle controller 1 of each vehicle. When the traveling request is previously assigned with a vehicle, the zone controller 2 transmits the traveling request received from the host system 3 to each vehicle controller 1.

The zone controller 2 receives positional information from the vehicle controllers 1 on all the vehicles traveling in the zone, generates traveling performance information in each zone based on the received positional information, and transmits the generated information to the host system 3. The traveling performance information includes the number of vehicles in each zone, positional information on each vehicle, and the like.

The zone controller 2 can be configured of a computer device. FIG. 3 is a block diagram illustrating a hardware configuration of the zone controller 2. As illustrated in FIG. 3, the computer device configuring the zone controller 2 comprises a CPU 201, a storage medium 202, a RAM 203, a communication interface 204, a user interface 205, and a wireless communication interface 206, and the components are connected with each other via a hub.

The CPU 201 controls other components, and sequentially executes the programs stored in the storage medium 202. The storage medium 202 is configured of HDD or SSD, and stores the programs required to generate a traveling instruction or traveling performance information therein. The RAM 203 is configured of

SRAM, DRAM or a flash memory, and reads and temporarily stores the programs stored in the storage medium 202 as needed when the CPU 201 executes the programs, respectively. The communication interface 204 communicates with the host system 3 via a LAN, receives a traveling request from the host system 3, and transmits traveling performance information to the host system 3. The user interface 205 is configured of a display, a keyboard, a mouse, and the like, and can accept user inputs and output information to the user. The wireless communication interface 206 wirelessly communicates with the vehicle controller 1, receives positional information from the vehicle controller 1, and transmits a traveling instruction to the vehicle controller 1. The zone controller 2 and the vehicle controller 1 can be configured to communicate with each other in a wired manner.

The host system 3 communicates with the zone controllers 2 and the setting update system 4 via a LAN constructed in the area.

The host system 3 receives traveling performance information from all the zone controllers 2 in the area. That is, the host system 3 collects the traveling performance information on all the vehicles in the area.

The host system 3 issues a traveling request based on traveling performance information received from the zone controllers 2 or a range of the number of vehicles updated in the setting update system 4. The traveling request is issued such that the number of vehicles in each zone is within the set range. The host system 3 transmits the issued traveling request to each zone controller 2 thereby to control the number of vehicles in each zone within the set range. For example, the host system 3 moves a vehicle from a zone in which more vehicles beyond the set ranges travels to other zone, and controls the number of vehicles in each zone within the set range.

The host system 3 transmits the generated traveling request, or the traveling performance information received from the zone controllers 2 to the setting update system 4, and receives an updated range of the number of vehicles, and the like from the setting update system 4.

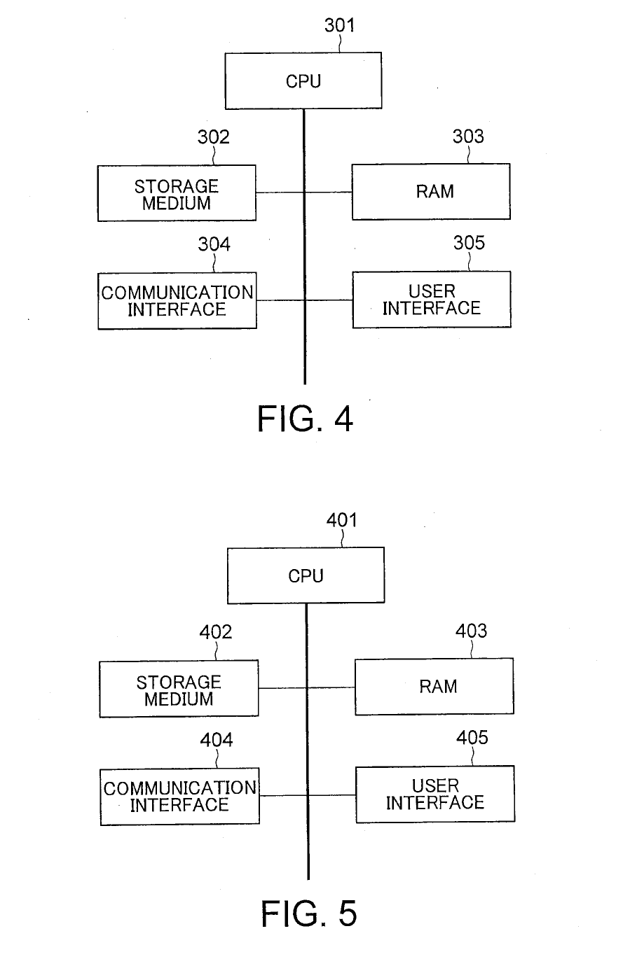

The host system 3 can be configured of a computer device. FIG. 4 is a block diagram illustrating a hardware configuration of the host system 3. As illustrated in FIG. 4, the computer device configuring the host system 3 comprises a CPU 301, a storage medium 302, a RAM 303, a communication interface 304, and a user interface 305, and the components are connected with each other via a hub.

The CPU 301 controls other components, and sequentially executes the programs stored in the storage medium 302. The storage medium 302 is configured of HDD or SSD, and stores the programs required to generate a traveling request therein. The RAM 303 is configured of SRAM, DRAM or a flash memory, and reads and temporarily stores the programs stored in the storage medium 302 as needed when the CPU 301 executes the programs, respectively. The communication interface 304 receives traveling performance information from the zone controllers 2 via a LAN and transmits a traveling request to the zone controllers 2, as well as transmits traveling request information or the like to the setting update system 4 and receives an updated range of the number of vehicles from the setting update system 4. The user interface 305 is configured of a display, a keyboard, a mouse and the like, and can accept user inputs and output information to the user.

A subsystem or sub-controller having a different control range may be provided between the zone controllers 2 and the host system 3 or at a higher order than the host system 3. The vehicle controller 1 of each vehicle may wirelessly communicate with the host system 3 without providing the zone controller 2. In this case, the host system 3 comprises a wireless communication interface, receives traveling performance information from the vehicle controller 1, and transmits a traveling request assigned with a vehicle to the vehicle controller 1.

The setting update system 4 communicates with the host system 3 via a LAN constructed in the area. The setting update system 4 receives traveling performance information or traveling request information from the host system 3, and updates a range of the number of vehicles set in each zone based on the received information. The setting update system 4 transmits the updated range of the number of vehicles to the host system 3. The host system 3 generates a traveling request based on the range of the number of vehicles received from the setting update system 4.

The setting update system 4 can be configured of a computer device. FIG. 5 is a block diagram illustrating a hardware configuration of the setting update system 4. As illustrated in FIG. 5, the computer device configuring the setting update system 4 comprises a CPU 401, a storage medium 402, a RAM 403, a communication interface 404, and a user interface 405, and the components are connected with each other via a hub.

The CPU 401 controls other components, and sequentially executes the programs stored in the storage medium 402. The storage medium 402 is configured of HDD or SSD, and stores the programs required to update a range of the number of vehicles in each zone. The RAM 403 is configured of SRAM, DRAM or a flash memory, and reads and temporarily stores the programs stored in the storage medium 402 as needed when the CPU 401 executes the programs, respectively. The communication interface 404 receives traveling performance information and traveling request information from the host system 3 via a LAN, and transmits an updated range of the number of vehicles, and the like to the host system 3. The user interface 405 is configured of a display, a keyboard, a mouse, and the like, and can accept user inputs and output information to the user.

As illustrated in FIG. 1, the setting update system 4 comprises the functional components such as a load rate calculation unit 41 (first calculation unit), a vehicle number/traveling rate relationship storage unit 42, an upper limit traveling rate calculation unit 43 (second calculation unit), and an upper limit vehicle number update unit 44 (first update unit).

The load rate calculation unit 41 (which will be called “calculation unit 41” below) calculates a load rate ρ in each zone. The load rate ρ is a parameter indicating a likelihood of a clog, and a clog is easily caused in a zone with a higher load rate ρ. The load rate ρ is a rate of performance traveling rate Q_{A} relative to critical traveling rate Q_{CR}, and is calculated at ρ=Q_{A}/Q_{CR}. The traveling rate described herein indicates the number of vehicles passing beyond a border in each zone per certain time. The traveling rate may employ the number of vehicles entering each zone or the number of vehicles exiting each zone per certain time.

The performance traveling rate Q_{A} is a performance value of the traveling rate. A vehicle is moved in response to a traveling request, and the performance traveling rate Q_{A} in each zone matches with the number of the traveling requests in each zone. The calculation unit 41 acquires the number of the traveling requests in each zone as performance traveling rate Q_{A} in each zone. The number of the traveling requests in each zone can be acquired from traveling request information received from the host system 3.

The critical traveling rate Q_{CR} is a maximum value of the traveling rate assumed for each zone. The calculation unit 41 acquires the critical traveling rate Q_{CR} from a vehicle number/traveling rate relationship stored in the vehicle number/traveling rate relationship storage unit 42 (which will be called “storage unit 42” below).

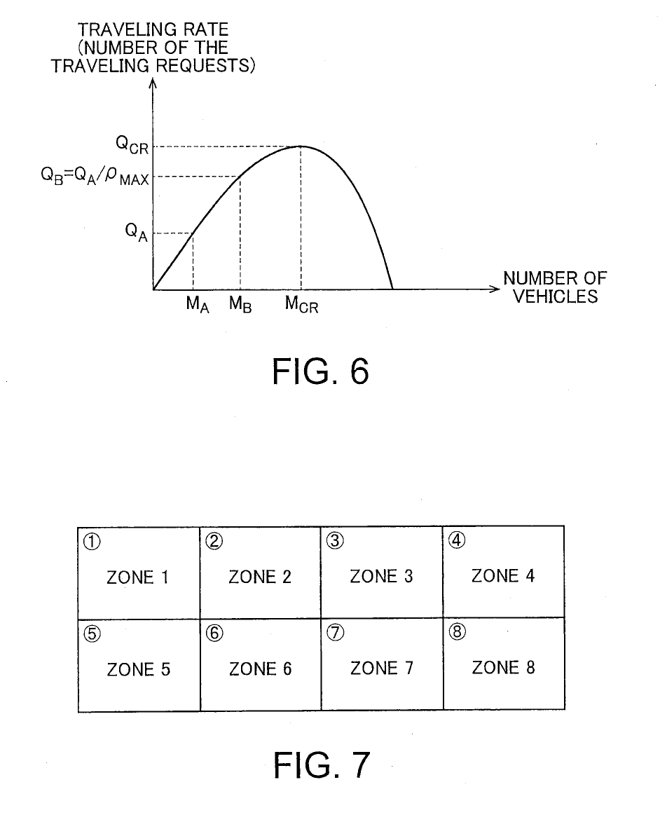

The vehicle number/traveling rate relationship indicates a correspondence between the number of vehicles and a traveling rate. The storage unit 42 stores a vehicle number/traveling rate relationship per zone therein. FIG. 6 is a diagram illustrating an exemplary vehicle number/traveling rate relationship. In FIG. 6, the vertical axis indicates an average value of the number of vehicles, and the horizontal axis indicates an average value of a traveling rate. Generally, for a relationship between the number of vehicles and a traveling rate, as the number of vehicles increases from 0, a traveling rate monotonically increases, the traveling rate reaches a peak (critical traveling rate Q_{CR}) at a predetermined number of vehicles (critical number of vehicles M_{CR}), and subsequently the traveling rate decreases as the number of vehicles increases. This indicates that when more vehicles than the critical number of vehicles M_{CR} travel in each zone, a clog is caused in the zone and the traveling rate decreases. The critical traveling rate Q_{CR} indicates a raveling rate at the critical number of vehicles M_{CR}, or a maximum value of the traveling rate in the vehicle number/traveling rate relationship. The vehicle number/traveling rate relationship is generated by an actual measurement result or simulation, and is stored in the storage unit 42 in a form such as equations or table.

The upper limit traveling rate calculation unit 43 (which will be called “calculation unit 43” below) calculates an upper limit traveling rate Q_{B} which is an upper limit value of the traveling rate in each zone based on a performance traveling rate Q_{A} in each zone and a maximum load rate ρ_{MAX} calculated by the calculation unit 41. The upper limit traveling rate Q_{B} is calculated by dividing the performance traveling rate Q_{A} in each zone by the maximum load rate ρ_{MAX}(Q_{B}=Q_{A}/ρ_{MAX}).

The upper limit vehicle number update unit 44 (which will be called “update unit 44” below) updates an upper limit number of vehicles M_{B} as an upper limit value of the number of vehicles based on the upper limit traveling rate Q_{B} and the vehicle number/traveling rate relationship. Specifically, as illustrated in FIG. 6, the update unit 44 acquires the number of vehicles smaller than a critical number of vehicles M_{CR} from among the numbers of vehicles corresponding to the upper limit traveling rate Q_{B} with reference to the vehicle number/traveling rate relationship and updates the upper limit number of vehicles M_{B} to the number of vehicles.

The calculation unit 41 preferably adjusts the load rate ρ in each zone such that when the calculated maximum load rate ρ_{MAX} is higher than 1, the load rates

in all the zones are uniformly reduced and the load rate ρ_{MAX} is 1 or less. This is because when the maximum load rate ρ_{MAX} is higher than 1, the upper limit traveling rate Q_{B} (Q_{B}=Q_{A}/ρ_{MAX}) is lower than the performance traveling rate Q_{A} in all the zones.

Such a method for adjusting a load rate ρ may employ a method for integrating the load rates ρ in all the zones by a predetermined value (<1), or a method for subtracting a predetermined value from the load rates ρ in all the zones, but is not limited thereto. The load rate ρ may be adjusted such that the maximum load rate ρ_{MAX} takes any setting value.

A setting update processing by the setting update system 4 according to the present embodiment will be described below with reference to FIGS. 7 to 15. In the following, a case in which an area includes eight rectangular zones as illustrated in FIG. 7 will be described by way of example, but the configuration of the area and zones is not limited thereto. Each zone in FIG. 7 is identified by a zone ID, and the zone ID indicates an i-th (i=1 to 8) zone as zone i.

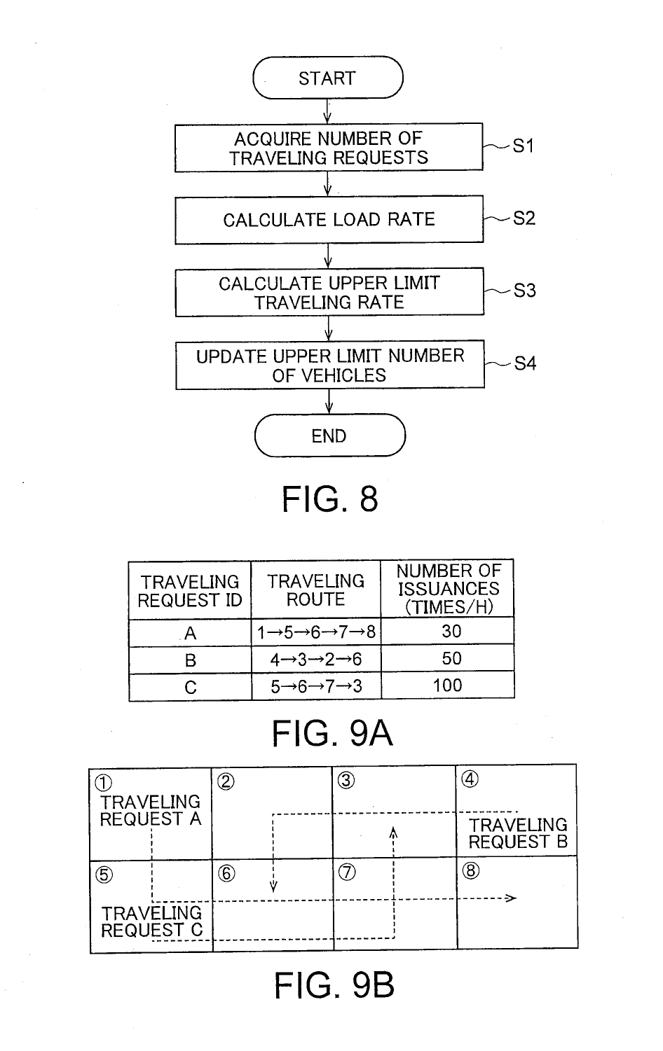

FIG. 8 is a flowchart illustrating the setting update processing. As illustrated in FIG. 8, when the setting update processing starts, the calculation unit 41 receives traveling request information from the host system 3, and acquires the number of the traveling requests in each zone (step S1).

FIGS. 9A and 9B are the explanatory diagrams for explaining traveling request information, where FIG. 9A is a diagram illustrating exemplary traveling request information received by the calculation unit 41. The traveling request information illustrated in FIG. 9A includes traveling request ID, traveling route designated by each traveling request, and the number of issuances of each traveling request. For example, the traveling request A with the traveling request ID of A designates a raveling route from zone 1 to zone 8, and is issued 30 times per hour. This indicates that 30 vehicles per hour move from zone 1 to zone 8 in response to the traveling request A. FIG. 9B is a diagram illustrating the traveling routes designated by the respective traveling requests in FIG. 9A on the area of FIG. 7 in broken lines.

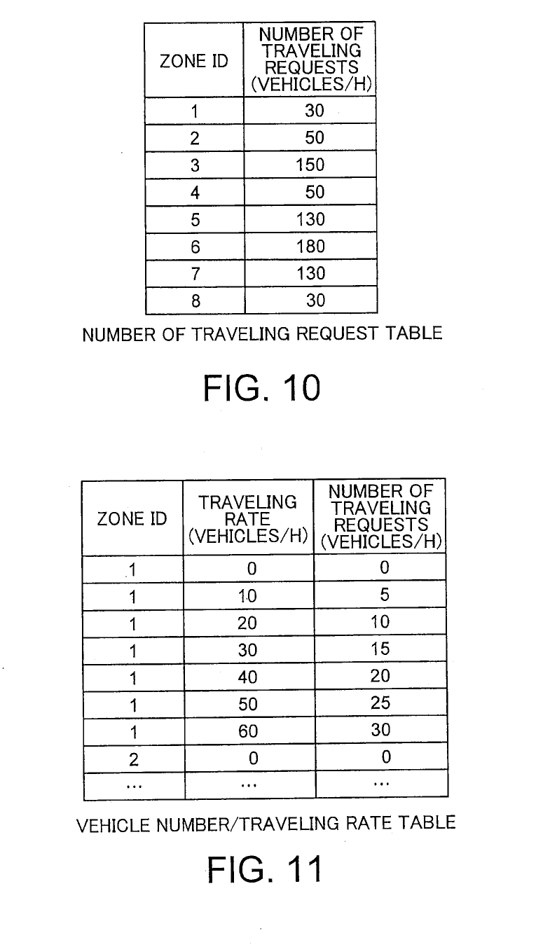

The calculation unit 41 acquires the number of the traveling requests in each zone based on the traveling request information as in FIGS. 9A and 9B. FIG. 10 illustrates an exemplary number of traveling request table indicating the number of the traveling requests acquired by the calculation unit 41 from the traveling request information in FIGS. 9A and 9B. In FIG. 10, the traveling rate indicates the number of vehicles passing beyond a border between the zones. In this case, for example, the performance traveling rate Q_{A} of zone 5 is a sum of the number of vehicles traveling in response to the traveling request A and the number of vehicles traveling in response to the traveling request C (see FIGS. 9A and 9B), and is calculated as a sum of the number of issuances of the traveling request A and the number of issuances of the traveling request C.

The traveling rate is not limited thereto, and may employ the number of vehicles entering a zone or the number of vehicles exiting a zone. For example, when the traveling rate employs the number of vehicles entering a zone, the performance traveling Q_{A} of zone 5 is the number of vehicles traveling in response to the traveling request A (see FIGS. 9A and 9B), and the number of issuances of the traveling request A is acquired. In any case, the performance traveling rate Q_{A} in each zone matches with the corresponding number of the traveling requests.

The calculation unit 41 then calculates a load ρ in each zone based on the number of the traveling requests and the vehicle number/traveling rate relationship (step S2). The calculation unit 41 first acquires a vehicle number/traveling rate relationship in each zone stored in a form such as equation or table in the storage unit 42 in order to calculate a load rate ρ.

FIG. 11 illustrates an exemplary vehicle number/traveling rate table indicating a vehicle number/traveling rate relationship in each zone stored in the storage unit 42. FIG. 11 illustrates only a range at a critical number of vehicles M_{CR} or less, and zone 2 and subsequent zones are omitted. The vehicle number/traveling rate table is generated by a measurement result or simulation in each zone. The generated vehicle number/traveling rate table may be updated periodically or at any timing. Further, the vehicle number/traveling rate table may have a plurality of patterns prepared per zone, and the vehicle number/traveling rate table to be used may be changed depending on traveling request information. For example, a vehicle number/traveling rate table per traveling direction in each zone or a vehicle number/traveling rate table per time zone may be prepared. Thereby, an accuracy of updating an upper limit number of vehicles can be enhanced.

The calculation unit 41 acquires a critical traveling rate Q_{CR} in each zone based on the vehicle number/traveling rate relationship. When the vehicle number/traveling rate relationship is discrete as in the vehicle number/traveling rate table of FIG. 11, the calculation unit 41 may acquire the critical traveling rate Q_{CR} from the traveling rates indicated in the vehicle number/traveling rate table, or may acquire a traveling rate calculated based on the traveling rates indicated in the vehicle number/traveling rate table as the critical traveling rate Q_{CR}. Such a method may employ a method for generating an approximate curve of the vehicle number/traveling rate relationship from the vehicle number/traveling rate table and acquiring a critical traveling rate Q_{CR} from the approximate curve.

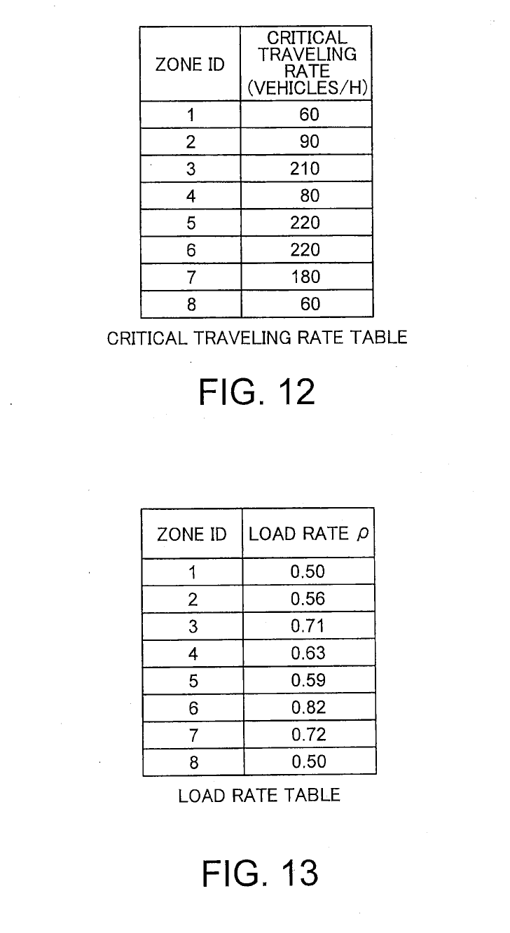

FIG. 12 illustrates an exemplary critical traveling rate table indicating a critical traveling rate Q_{CR} in each zone. The critical traveling rate table of FIG. 12 is generated from the vehicle number/traveling rate table of FIG. 11, and a maximum value of the vehicle number/traveling rate table is acquired as a critical traveling rate Q_{CR}. The calculation unit 41 may generate the critical traveling rate table as illustrated in FIG. 12 based on the vehicle number/traveling rate relationship, or the critical traveling rate table may be previously stored in the storage unit 42.

The calculation unit 41 calculates a load rate ρ in each zone by dividing the performance traveling rate Q_{A} by the critical traveling rate Q_{CR}. FIG. 13 illustrates an exemplary load rate table indicating a load rate ρ in each zone. The load rate table of FIG. 13 is generated based on the number of traveling request number table of FIG. 10 and the critical traveling rate table of FIG. 12. In FIG. 13, a load rate of 0.82 in zone 6 is the maximum load rate ρ_{MAX}. When the maximum load rate ρ_{MAX} is higher than 1, the calculation unit 41 uniformly lowers the load rates

in all the zones such that the maximum load rate ρ_{MAX} is 1 or less.

The calculation unit 43 then calculates an upper limit traveling rate Q_{B} in each zone (step S3). The upper limit traveling rate Q_{B} is calculated by dividing the number of the traveling requests Q_{A} in each zone by the maximum load rate ρ_{MAX}. The calculation unit 43 acquires the number of the traveling requests Q_{A} and the maximum load rate ρ_{MAX} from the calculation unit 41.

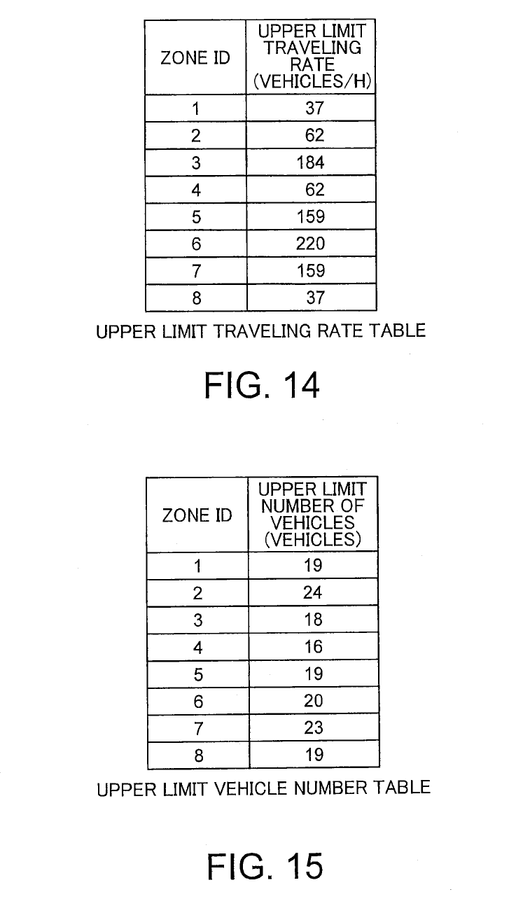

FIG. 14 illustrates an exemplary upper limit traveling rate table indicating an upper limit traveling rate Q_{B} in each zone calculated by the calculation unit 43. The upper limit traveling rate table of FIG. 14 is generated based on the number of traveling request table of FIG. 10 and the load rate table of FIG. 13. Therefore, an upper limit traveling rate Q_{B} in each zone is obtained by dividing the number of the traveling requests Q_{A} in each zone by the load rate (maximum load rate ρ_{MAX}) in zone 6.

The update unit 44 acquires the number of vehicles corresponding to the upper limit traveling rate Q_{B} in each zone calculated by the calculation unit 43 with reference to the vehicle number/traveling rate relationship in each zone, and updates the upper limit number of vehicles M_{B} to the acquired number of vehicles (step S4). When the vehicle number/traveling rate relationship is an equation, the update unit 44 updates the upper limit number of vehicles M_{B} to the number of vehicles acquired by substituting the upper limit traveling rate Q_{B} into the equation. When the vehicle number/traveling rate relationship is discrete, the update unit 44 updates the upper limit number of vehicles M_{B} to the number of vehicles corresponding to a closest traveling rate to the upper limit traveling rate Q_{B}, or the number of vehicles calculated by use of an approximate equation generated from the vehicle number/traveling rate relationship.

FIG. 15 illustrates an upper limit vehicle number table indicating an upper limit number of vehicles M_{B} in each zone. In FIG. 15, the upper limit number of vehicles M_{B} in zone 6 with a maximum load rate ρ_{MAX} matches with the critical number of vehicles M_{CR}, and the upper limit numbers of vehicles M_{B} in other zones are lower than the critical number of vehicles M_{CR} in each zone.

The setting update system 4 performs the setting update processing periodically or at any timing, thereby updating an upper limit number of vehicles M_{B} set in each zone.

The host system 3 monitors the number of vehicles in each zone based on traveling performance information received from the zone controllers 2. The host system 3 issues a traveling request to a zone in which the number of vehicles exceeds an upper limit number of vehicles M_{B}, and moves some vehicles in the zone to other zone. Thereby, the number of vehicles in each zone is controlled at the upper limit number of vehicles M_{B} or less.

As described above, the setting update system 4 according to the present embodiment can automatically update an upper limit number of vehicles M_{B} set in each zone to a critical number of vehicles M_{CR} or less based on the number of the traveling requests in each zone. The host system 3 controls the vehicles in each zone to be equal to or less than an upper limit number of vehicles M_{B} updated by the setting update system 4, and the number of vehicles in each zone is controlled at a critical number of vehicles M_{CR} or less. Therefore, the vehicle control system according to the present embodiment can prevent a clog in the area from occurring.

The setting update system 4 according to the present embodiment sets an upper limit number of vehicles M_{B} in a zone other than the zones with a maximum load rate ρ_{MAX} to be smaller than a critical number of vehicles M_{CR} in each zone. Thereby, the number of vehicles in a zone around the zone with the maximum load rate ρ_{MAX} is limited, which prevents a vehicle from entering the zone with the maximum load rate ρ_{MAX} from the surrounding zone. Thereby, a clog can be further prevented from occurring.

### Second Embodiment

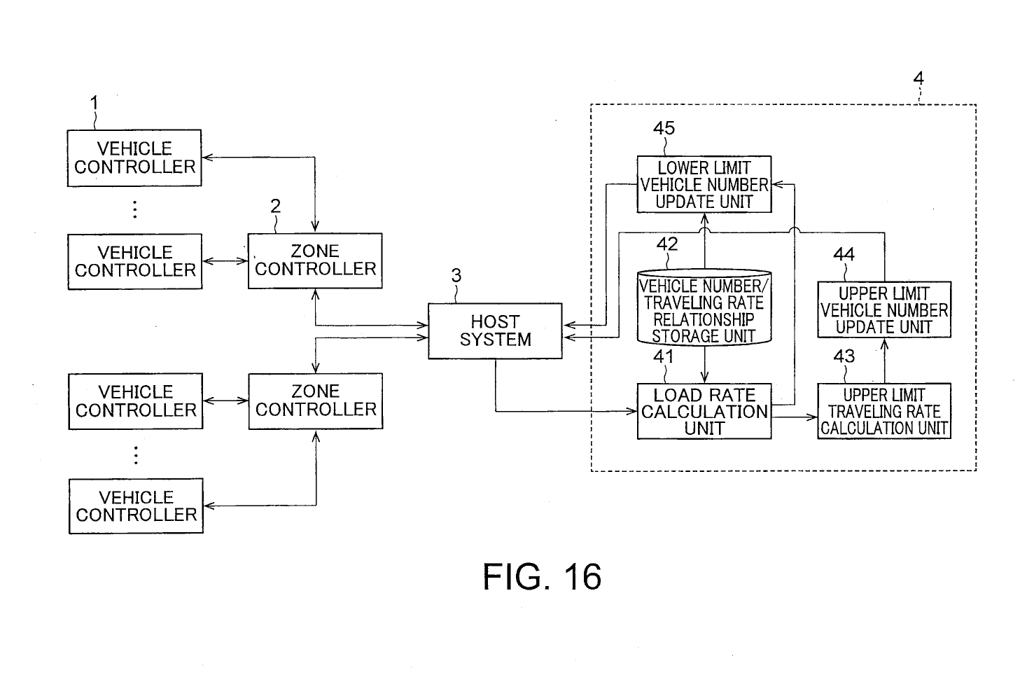

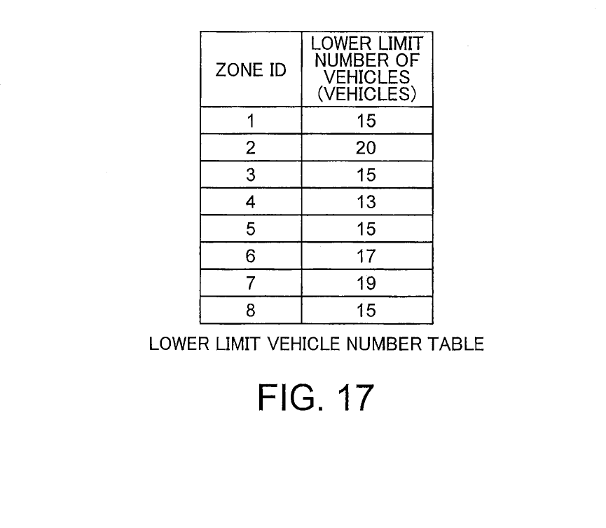

A vehicle control system and a setting update system according to a second embodiment will be described below with reference to FIGS. 16 and 17. FIG. 16 is a block diagram illustrating a functional configuration of the vehicle control system according to the present embodiment. As illustrated in FIG. 16, in the present embodiment, the setting update system 4 comprises a lower limit vehicle number update unit 45 (second update unit). Other components are the same as the first embodiment.

The lower limit vehicle number update unit 45 (which will be called “update unit 45” below) updates a lower limit number of vehicles M_{A} as a lower limit value of the number of vehicles in each zone based on the number of the traveling requests in each zone and a vehicle number/traveling rate relationship. The number of the traveling requests in each zone is acquired from the calculation unit 41, and the vehicle number/traveling rate relationship is acquired from the storage unit 42. The update unit 45 acquires the number of vehicles (see FIG. 6) corresponding to a performance traveling rate Q_{A} matching with the number of the traveling requests in each zone with reference to the vehicle number/traveling rate relationship, transmits the acquired number of vehicles to the host system 3, and updates the lower limit number of vehicles M_{A} to the acquired number of vehicles. FIG. 17 illustrates a lower limit vehicle number table indicating a lower limit number of vehicles M_{A} in each zone updated by the update unit 45.

The setting update system 4 performs the setting update processing periodically or at any timing, thereby updating a lower limit number of vehicles M_{A} set in each zone.

The host system 3 monitors the number of vehicles in each zone based on traveling performance information received from the zone controllers 2. If there is a zone in which the number of vehicles is lower than the lower limit number of vehicles M_{A}, the host system 3 issues a traveling request to vehicles in other zones, and moves the vehicles to the zone in which the number of vehicles is lower than the lower limit number of vehicles M_{A}. Thereby, the number of vehicles in each zone is controlled at the lower limit number of vehicles M_{A} or more.

As described above, the setting update system 4 according to the present embodiment can automatically update a lower limit number of vehicles M_{A} set in each zone to the number of vehicles corresponding to the number of the traveling requests (performance traveling rate Q_{A} ) based on the number of the traveling requests in each zone. The host system 3 controls the vehicles in each zone at the lower limit number of vehicles M_{A} updated in the setting update system 4 or more, and the number of vehicles in each zone is controlled at the number of vehicles corresponding to the number of the traveling requests or more. Therefore, the vehicle control system according to the present embodiment can prevent an opportunity loss for a traveling request issued to each zone. The opportunity loss described herein indicates that there is no vehicle corresponding to an issued traveling request due to a lack of vehicles in a zone.

### Third Embodiment

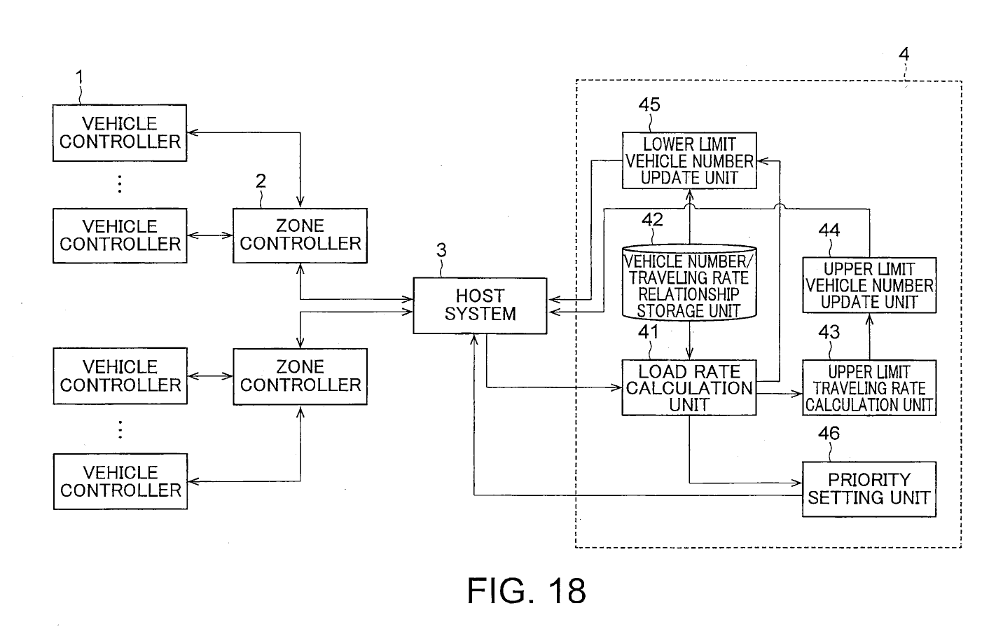

A vehicle control system and a setting update system according to a third embodiment will be described below with reference to FIGS. 18 to 20. FIG. 18 is a block diagram illustrating a functional configuration of the vehicle control system according to the present embodiment. As illustrated in FIG. 18, in the present embodiment, the setting update system comprises a priority setting unit. Other components are the same as the second embodiment.

The priority setting unit 46 (which will be called “setting unit 46” below) acquires a load rate ρ in each zone from the calculation unit 41, and sets a priority for each zone according to the load rate in each zone. The host system 3 controls the number of vehicles according to the priority set by the setting unit 46.

The setting unit 46 selects a bottleneck zone based on a load rate ρ, for example, and sets a higher priority in the bottleneck zone than other zones. The bottleneck zone described herein is a zone with a higher load rate ρ, or a zone in which a clog is easily caused. A bottleneck zone may be arbitrarily selected, but the setting unit 46 selects, as a bottleneck zone, a zone with a maximum load rate ρ, a zone with a load rate ρ at a predetermined threshold or more, or zones at predetermined orders in descending order of load rate ρ, and sets a higher priority therein than other zones.

The setting unit 46 may set a higher priority in a neighboring zone than other zones. The neighboring zone is a zone having a higher impact on the bottleneck zone in which a clog is easily caused. The setting unit 46 employs any neighboring zone selection method, but the setting unit 46 selects, as a neighboring zone, a zone adjacent to the bottleneck zone, a zone positioned within a predetermined range from the bottleneck, or a zone with a high association with the number of vehicles in the bottleneck. The setting unit 46 sets a higher priority in order of bottleneck zone, neighboring zone, and other zone in this order.

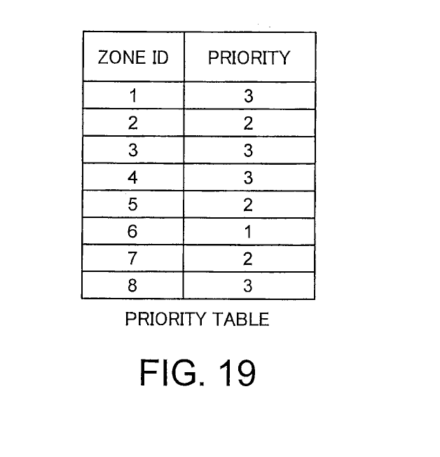

FIG. 19 illustrates a priority table indicating a priority in each zone set by the setting unit 46. In FIG. 19, the setting unit 46 selects zone 6 with a maximum load rate ρ as a bottleneck zone, and selects zones 2, 5 and 7 adjacent to zone 6 as neighboring zones. Then, the bottleneck zone is set at priority 1, the neighboring zones are set at priority 2, and other zones are set at priority 3. The method for selecting a bottleneck zone and a neighboring zone is not limited thereto.

As described above, the setting update system 4 according to the present embodiment sets a high priority to a bottleneck zone in which a clog is easily caused or a neighboring zone which has a higher impact on the bottleneck zone depending on a load rate ρ in each zone. The host system 3 controls the number of vehicles according to a priority, and when the numbers of vehicles in the bottleneck zone (neighboring zone) and other zones exceed an upper limit number of vehicles, the host system 3 controls the number of vehicles in the bottleneck zone (neighboring zone). In this way, the vehicle control system according to the present embodiment preferentially controls the number of vehicles in a zone in which a clog is easily caused or a zone having a higher impact on an occurrence of a clog ahead of the number of vehicles in a zone in which a clog is rarely caused, thereby efficiently preventing a clog from occurring.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A setting update system that updates an upper limit value of the number of vehicles, which travel in an area including a plurality of zones in response to a traveling request, set per zone depending on the number of the traveling requests in each of the zones.

2. The system according to claim 1,
wherein the number of the traveling requests in each of the zones indicates the number of the traveling requests to pass the vehicles beyond a border in each of the zones, the number of the traveling requests to enter the vehicles to each of the zones, or the number of the traveling requests to exit the vehicles from each of the zones.

3. The system according to claim 1, comprising:
a first calculation unit that calculates a load rate in each of the zones based on the number of the traveling requests in each of the zones;
a second calculation unit that calculates an upper limit value of a traveling rate in each of the zones based on a maximum load rate calculated in the first calculation unit and the number of the traveling requests in each of the zones; and
a first update unit that updates the upper limit value of the number of vehicles in each of the zones based on the upper limit value of the traveling rate and a relationship between the traveling rate and the number of vehicles.

4. The system according to claim 1, comprising:
a second update unit that updates a lower limit value of the number of vehicles in each of the zones based on the number of the traveling requests in each of the zones and a relationship between the traveling rate and the number of vehicles.

5. The system according to claim 3, comprising:
a priority setting unit that sets a priority for each of the zones depending on the load rate in each of the zones.

6. A vehicle control system comprising:
the setting update system according to claim 1; and
an issuance unit that issues the traveling request to control the vehicles such that the number of vehicles in each of the zones is within a range of the number of the vehicles set by the setting update system.
